(19) United States
(12) Patent Application Publication
(10) Pub. No.: US 2012/0209628 A1
(43) Pub. Date: Aug. 16, 2012

(54) SYSTEM FOR MATCHING INDIVIDUALS WITH HEALTH CARE PROVIDERS AND METHODS THEREOF

(76) Inventors: Robert H. Tamis, Paradise Valley, AZ (US); Marc A. Tamis, Grayslake, IL (US); Marcia K. Horn, Phoenix, AZ (US)

(21) Appl. No.: 13/455,537

(22) Filed: Apr. 25, 2012

Related U.S. Application Data
(62) Division of application No. 12/651,041, filed on Dec. 31, 2009.
(60) Provisional application No. 61/204,068, filed on Dec. 31, 2008.

(51) Int. Cl. G06Q 50/24

(52) U.S. Cl. 705/3

(57) ABSTRACT

A system for matching individuals with health care providers and methods thereof. The system is capable of collecting information from health care providers and individuals and thereafter matching individuals with clinical trial providers based upon that information by utilizing coding to eliminate medical terminology ambiguity. The system continually updates the degree of likelihood of a match of a health care provider with an individual based upon individual feedback and clinical trial provider feedback relating to results achieved from treatment provided by a given health care provider. The system also notifies individuals of experimental clinical trials that can be potentially applicable to the individual based upon the information provided by the individual.

### REFERENCE TO RELATED APPLICATIONS

This disclosure is a divisional application of U.S. application Ser. No. 12/651,041 titled SYSTEM FOR MATCHING INDIVIDUAL WITH HEALTH CARE PROVIDERS AND METHOD THEREFOR that was filed on Dec. 31, 2009 which claims priority to U.S. Provisional Application Ser. No. 61/204,068 titled the same that was filed on Dec. 31, 2008 by the same, all of which have been assigned to the International Cancer Advocacy Network (ICAN).

### TECHNICAL FIELD

The present disclosure generally relates to disease therapy, and more specifically, to a system and method for matching individuals having disease, with clinical trial facilities so that treatments can be provided for those particular types of infirmities and diagnoses.

### BACKGROUND

Less than 5% of eligible patients ever enroll in a clinical trial. One obvious reason for this is the fact that it can be difficult for an individual to be aware of relevant clinical trials, treatments, and procedures. Although there are numerous search engines accessible to individuals and physicians, these search engines have striking deficits. For example, available search engines often fail to find all relevant clinical trials being conducted, and also fail to list every type of cancer relevant to a particular clinical trial. Furthermore, these search engines often provide information that is inadequate to determine if a clinical trial is a good match for an individual. Moreover, the terminology used by one search engine or clinical trial can be inconsistent with the terminology used by other search engines or clinical trials, causing much of the web-based information regarding clinical trials, treatments, and procedures to be confusing to potential individuals, making it difficult to efficiently match clinical trials with individuals.

Further making the currently used search engines ineffective is the fact that individuals, physicians, or advocates must still make contact with clinical trial research or trials nurses (or clinical study coordinators) outside of the search engine system, which can be a time-consuming and arduous task. Accordingly, there appears to be no present method to find all relevant clinical trials, treatments, procedures, and methods of treatment that an individual, physician, or advocacy group seeks.

Therefore, it would be beneficial to provide a search engine, and an overall operative system, that overcomes these issues. A system shown below will overcome the limitations of mismatching individual's actual diagnoses with particular clinical trials, failing to delineate every relevant clinical trial, and failing to account for the confusing language, ambiguous medical abbreviations, and other terminology that sabotages the results of many meticulous searches that are conducted in good faith by professionals in oncology, medical research, as well as by the lay public. These goals are accomplished by the present disclosure which provides an individualized disease specific medical record system along with a coding system that effectively links individuals to information regarding treatment and clinical trials, notifying health care providers of potentially interested individuals, and updating the likelihood of a successful match of clinical trial providers with an individual having a specific ailment, disease, diagnosis, or symptom.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present disclosure, a computer-implemented method for setting up individuals with clinical trial providers is provided. The computer-implemented method includes receiving medical information from an individual. In addition, the computer-implemented method includes matching the individual to the clinical trial providers using the medical information. The computer-implemented method also includes releasing private information of the individual to the matched clinical trial providers when authorized by the individual.

In accordance with another aspect of the present disclosure, a medical record system is provided. The medical record system includes a database for storing information about at least one participating clinical trial facility that provides treatment for one or more disease classifications. In addition, the medical record system includes at least one processor and a memory operatively coupled to the processor, the memory storing program instructions which, when executed by the processor, causes the processor to perform processes. The processes include receiving at least one individual disease classification. In addition, the processes include enabling a clinical trial facility of the at least one participating clinical trial facility to become aware of the individual by matching the one or more disease classifications of the clinical trial facility with the individual disease classifications.

In accordance with yet another aspect of the present disclosure, a system is provided. The system includes at least one individual providing disease specific information. In addition, the system includes a medical information network for receiving the disease specific information from the individual. The system also includes at least one clinical trial facility for retrieving the disease specific information from the medical information network, the at least one clinical trial facility providing treatments for the disease specific information of the at least one individual.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a flow chart illustrating routines for matching individuals with clinical trial providers in accordance with one aspect of the present disclosure;

FIG. 2 is an exemplary environment that can be used to perform the illustrative routines in accordance with one aspect of the present disclosure;

FIG. 3A represents a typical form for retrieving information from an individual in accordance with one aspect of the present disclosure;

FIG. 3B depicts a typical message displayed when a match between the individual and the clinical trial provider is made in accordance with one aspect of the present disclosure;

FIG. 3C shows a typical contact request form in accordance with one aspect of the present disclosure;

FIG. 3D provides a typical prompt for denying or allowing access to the individual's confidential information in accordance with one aspect of the present disclosure;

FIG. 3E depicts another typical prompt for requesting various information regarding the status and satisfaction of their treatment or program in accordance with one aspect of the present disclosure;

FIG. 4 provides an exemplary flow chart for registering individuals in accordance with one aspect of the present disclosure;

FIG. 5 depicts illustrative features from the perspective of an individual in accordance with one aspect of the present disclosure;

FIG. 6 shows illustrative features from the perspective of a pharmaceutical coordinator in accordance with one aspect of the present disclosure;

FIG. 7 diagrams illustrative features from the perspective of a professional subscriber in accordance with one aspect of the present disclosure; and

FIG. 8 shows illustrative features from the perspective of a research institution in accordance with one aspect of the present disclosure.

### DESCRIPTION OF THE APPLICATION

The description set forth below in connection with the appended drawings is intended as a description of presently-preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Overview

Generally described, the present disclosure relates to medical information, and more particularly, to a system and method for matching individuals having disease or conditions, with clinical trial facilities that can provide treatment for those particular types of infirmities. In one illustrative embodiment, a system for matching individuals with clinical trial providers is provided. The system can be capable of collecting information from clinical trial providers and individuals. Thereafter, the system can match the individuals with the clinical trial providers based upon the received information by utilizing codes to eliminate ambiguous medical terminology. The system can continuously update the likelihood of a match of a clinical trial provider with an individual based upon patient and clinical trial provider feedback relating to results achieved from treatment provided by a given health care provider. The system can also notify individuals of experimental clinical trials that can be potentially applicable to the individual based upon the information provided by the individual.

In another illustrative embodiment, individuals can be matched with clinical trial providers through a disease or condition specific medical record system. The system can use the International Classification of Diseases Clinical Modification diagnosis coding (ICD-CM coding). The ICD-CM coding can identify over-7000 different cancer histology types and other diseases undergoing clinical trial treatment and evaluation. The system can be automated or semi-automated. The system can collect relevant information from individuals and/or their health care providers and use that information to match individuals with clinical trial facilities. The system can ensure that ICD-CM coding matches cross-terminology so that regardless of the specific wording entered into the system by those participating, the same code can be applied to interchangeable terms. This can eliminate terminology confusion that presently exists. By using specific ICD-CM coding, the system can identify the specific disease or condition of participating individuals. Typically, physicians participating in the system have the ICD-CM coding number in their patient's records, while the clinical trial facilities participating have access to a list of ICD-CM codes and the terms they represent, thereby enabling a given clinical trial facility to become aware of individuals matching specific criteria represented by the ICD-CM codes. The system can also implement up-to-date software to create a secure “closed cyberspace” to ensure protection and privacy of the medical records and personal data. Generally, this meets or exceeds present HIPAA requirements.

In yet another illustrative embodiment, a system can provide detailed disease or condition-specific questionnaires to enable various individuals, physicians, and health care providers to effectively submit information regarding medical and surgical criteria, including treatment history, as well as information regarding characteristics relating to tumors or other diseases, such as tumor markers or biomarkers and information relating to screening through genetic testing. Individuals can also provide information regarding the severity or stage of their disease or condition, so they can be given special attention, such as expedited admission to a particular clinical trial. The information collected can then be available for inspection by individuals and physicians participating in the system, and can also be used by the various clinical trial facilities for data mining purposes. This information can then be used to match individuals with clinical trial facilities based upon the specific types of treatment offered or desired, thereby enabling users to find methods of treatment specifically applicable to their situation. Furthermore, the system can automatically notify individuals when newly discovered information relevant to their specific situation is entered into the system, such as when a new clinical trial, drug, gene, or biomarker applicable to their situation is announced.

In another illustrative embodiment, the system can assign an individual identity code to each participating individual. The individual's information and individual identity code can be sent to clinical trial facilities that provide medication or clinical trials for individuals matching the criteria provided by the particular individual. If the clinical trial facilities determine that the individual represented by the individual identity code is a potential match for their services, the clinical trial facilities can request contact information for the potential individual via the system administrator, or an automated protocol within the system, which ensures the identity of the individual is protected. Typically, the private information can be released only upon the individual's consent. For example, following a contact request by clinical trial facilities, the individual can be alerted to the desired contact and be provided with information regarding the clinical trial facilities that desire to contact him/her. The potential individual can then release his/her private information to the requesting clinical trial facilities if so desired, or simply deny the request. Physicians can also access information contained within the system, although they similarly are unable to access specific individual medical records without the patient's consent, and they are not allowed access to other private patient information.

In still yet another illustrative embodiment, the abovementioned system can utilize different codes for matching individuals suffering from any type of disease or ailment, such as diabetes, hypertension, or multiple sclerosis, with clinical trial providers involved in the treatment in those specific medical areas.

While numerous illustrative embodiments were shown above, one skilled in the relevant art will appreciate that features within those embodiments can be interchanged, replaced, or combined. Furthermore, those embodiments were for purposes of illustration and should not be construed as limiting the scope of the present disclosure. Other embodiments will become apparent from the following description.

Operative System

Described above, numerous embodiments were provided for matching individuals with clinical trial facilities. Those described systems and methods can also be incorporated into a broader operative system that can provide numerous features beyond matching capabilities. In essence, the system can be a medical tracking system that can provide services to individuals. Users of the system, in the U.S. and abroad, can include, but are not limited to, patients, patient families, patient friends and associates, surgical oncologists, medical oncologists, and radiation oncologists, physicians, whether primary care or specialists, hospitals and medical centers, universities and research institutes, pathology, tissue analysis, drug assay, and genetics laboratories, contract research organizations, clinical trials coordinators/clinical studies coordinators, cancer cooperative groups and other clinical trials medical groups, oncology nurses, basic science and medical researchers, National Institutes of Health employees, Food and Drug Administration employees and employees of regulatory agencies outside the U.S., patient advocacy organizations, and other industries. The system described herein can encompass both pay-for services or non-paying services.

The operative system can include the search engine described above and can also provide a full service facility where individuals, physicians, and clinical trial facilities can interact and communicate with each other through a network. Typically, this interaction can take place through logical connections that can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks.

The operative system encompassing the search engine described above can provide a full service facility where individuals, physicians, and clinical trial facilities can interact and communicate with each other through a network. Typically, this interaction can take place through logical connections that can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks.

The operative system, in typical embodiments, can receive an individual's medical history and family history. This information can be stored on a database where the information can be accessed and maintained. Medications, both past and current, can also be kept track of by the system. If the individual uses the information in the future, the system can be easily accessed and the information can be distributed to the individual through the search engine. The ability to search back for information can be a valuable tool within the operative system.

In addition thereto, the operative system can disclose certain aspects about the patients so that their public information can be retrieved. If a patient decides to pursue a specific treatment, the individual can provide their personal information to the specific treatment center. The system can allow documents to follow the individual even though the individual changes physicians, places of residence, etc. through their lifetime.

The operative system can also provide other features. These features can include an information repository. The repository can maintain published articles that reference specific types of treatments being used. Furthermore, the articles can include statistical information on successful treatments and the ratios thereof. Of value to the individuals can be the access to numerous pharmacies, drug companies, and drugs that are now available or in research. The operative system can bring together the medical community and those seeking medical information.

Through the operative system, the medical and related or ancillary communities can gain access to statistical and research information in regional and global areas. The system can track trials and results in different regions. For example, the success rate for treatments in California can be different from those provided in New York. The system provides for verified data, random searches, credible sources, etc. Furthermore, this system makes individuals, physicians, and clinical trial facilities accountable.

The operative system described above can use across the board standardization in codes, names, etc. generic, common, proper name, and unified code references that organizations create. Furthermore, the system can include any and all diseases, conditions, etc. and is not limited to cancer. In typical embodiments, there can be a complete cross reference in both US and European formats. The system can be compliant with Globally Unified Standardizations.

In some embodiments, the operative system can provide interfaces for physicians, hospitals, pharmacies, etc. Generally, this occurs through a graphical user interface running atop a browser. The browser can connect to the Internet or similar network. The system can also provide automated reminders, notifications, refills, emails, faxes, voice mails, etc. The system can provide a complete record keeping for each individual including, but not limited to, pathology reports, diagnostic imaging, physician notes, notes, reports, and any other obtainable information such as insurance records.

The operative system can also provide medication tracking, history, automated refill, drug interaction, etc. Some embodiments of the system can include living wills, power of attorneys, and any other documents that can be stored, faxed, e-mailed, printed, and accessed by whomever the individual authenticates. The interface provided herein can automatically disseminate information to and from a physician's office, hospital, lab, pharmacy, etc.

In addition to those features presented above, the operative system can include fund raising capabilities by both organizations as well as individuals. The system can include on-line community resources, blogs (personal, group, etc.), forums, podcasts, other forms of communication, etc. The system can provide for non-profit and for-profit. A community volunteer database can also be included. Internal and external interfaces to automate disseminating and retrieval of information can be provided.

The nature of the present disclosure is such that one skilled in the relevant art of writing computer executable code (i.e., software) can implement the described functions and features using one or more of a combination of popular computer programming languages and developing environments including, but not limited to C, C++, C#, Groovy, Scala, Ruby, Python, Visual Basic, JAVA, PHP, HTML, XML, ACTIVE SERVER PAGES, JAVA server pages, servlets, MICROSOFT .NET, and a plurality of various development applications.

While the operative system was generally presented as a medical information network, one skilled in the relevant art will appreciate that the system can be expanded to the legal field, cooking field, automotive field, etc., thus making the present disclosure applicable to a variety of fields.

Matching

In general, a system for matching individuals with clinical trial providers is disclosed. The system can include collecting and housing information provided by a plurality of health care providers specializing in cancer or other disease treatments, such as universities, academic centers or institutes performing clinical trials, pharmaceutical and biotech companies, and the National Institute of Health (NIH) and Cancer Cooperative Groups conducting clinical trials. The system can also include collecting and housing information provided by a plurality of individuals diagnosed with cancer, other diseases, ailments, conditions, etc. being evaluated in clinical trial settings. In addition, the system can include a coding system for matching particular individuals with specific health care providers based upon the information they provide.

The information collected from the clinical trial providers can include, but is not limited to, information relating to the specific aspects of the cancer or disease being evaluated in the clinical trial setting, patient requirements to enter the clinical trial, and the specific type of treatment being offered in the clinical trial setting. The information provided by the individual patient includes, but is not limited to, information relating to the symptoms experienced, the stage of illness, the types of treatments experienced to date, the types of medical, surgical, or radiation treatment received to date, and laboratory testing including, but not limited to, biomarkers and genetic markers, all organized in a individualized disease-specific medical record system that is portable. Such a patient profile can also delineate the specific results the individuals attribute to their past treatment, types of treatment the individual is currently seeking, and the criteria of health care providers which the individual desires to contact.

As the system obtains the information provided by clinical trial providers and individuals, the system compiles the information using a system that assigns a code to each of the various types of information. As more and more data is accumulated and cross-referenced for correlations, the method of the present disclosure is capable of mapping trends relating to successful treatment of a given illness and predicting what forms of treatment can be effective for a specific individual. The system then matches each individual that is most likely to benefit from the services of specific clinical trial providers with those providers based upon the codes assigned, and thereafter provides the individuals with information regarding the applicable clinical trial providers.

Similarly, the system provides clinical trial providers with information representing individuals, who are kept anonymous, that can be of potential interest to the clinical trial provider. The clinical trial provider can then use the system to express a desire to be connected with the anonymous individual, at which point the individual is notified of the desired contact and provided with information relating to the clinical trial provider seeking contact. Thereafter, the individual decides whether or not to establish contact with the clinical trial provider. Accordingly, the clinical trial provider is then either provided with the information of the individual who desires to establish contact with the clinical trial provider, or, alternatively, the clinical trial provider is notified that the individual has rejected the clinical trial provider's contact request. While in one embodiment, the individual is queried and given the option to accept communication from a clinical trial provider, it should be clearly understood that substantial benefit could be derived from an alternative embodiment of the present disclosure in which individual participants consent to being contacted by a clinical trial provider. In such an embodiment, once a clinical trial provider desires to contact an individual based on the correlation of data, the clinical trial provider could simply do so.

The system also can make ongoing requests from the individual and their treating clinical trial providers for information regarding the progress of the individual's treatment including, but not limited to, results achieved and the individual's degree of satisfaction with the treatment. This information can then again be compiled by the system to enable the system to continually update and improve its method for matching individuals with clinical trial providers, thereby enabling the system to map the trends of various treatments and their effectiveness.

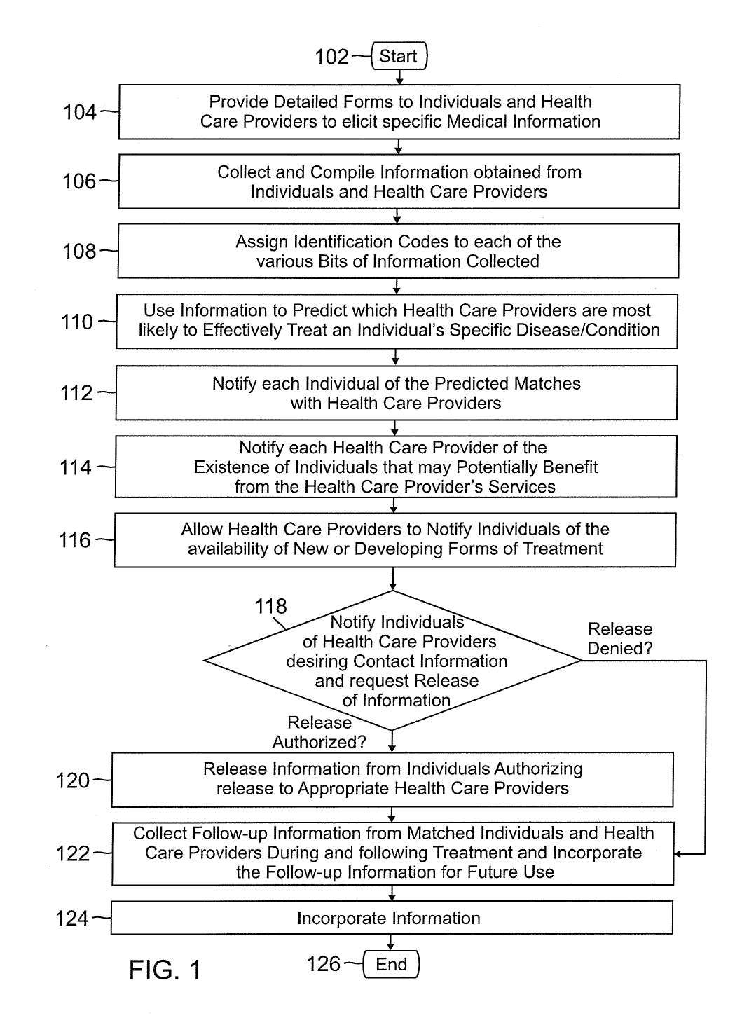

With reference now to the search engine and in particular FIG. 1, a flow chart illustrating routines for matching individuals with clinical trial providers in accordance with one aspect of the present disclosure is provided. While in the shown embodiment the system can be used to match individuals diagnosed with cancer with the appropriate clinical trial providers, it should be clearly understood that substantial benefit could be derived from an alternative embodiment of the present disclosure in which individuals suffering from non-cancer related illnesses are matched with the appropriate clinical trial providers. Furthermore, those routines provided within FIG. 1 are for illustrative purposes and show one embodiment, which is not intended to limit to the scope of the present disclosure.

As shown the routines can begin at block 102. At block 104, the system can provide detailed forms to individuals and health care providers to elicit specific medical information. The forms can typically include fields such as name, age, address, email address, and disease by name or ICD-CM coding. Generally, the forms can be filled in electronically. For example, a pop-up box can be displayed when the user clicks on an associated field. The individual can also enter information directly into an associated box associated with the field. While several fields were shown, one skilled in the relevant art will appreciate that there can be many types of fields that can be displayed to the user and thereafter be filled with information. It should be understood that these forms are designed to elicit specific medical information from individuals and health care providers.

At block 106, the system collects and compiles the information using the provided forms from the individuals and the health care providers who agree to participate in the system. Typically, this can be performed over a network that is or is not directly connected to the information provider. In one embodiment, the system can store the information in a database or other type of storage device. Numerous types of data storage methods exist and are incorporated within the present disclosure.

The system can then assign different identification codes to each individual and health care provider participating in the system at block 108. The system can also assign identification codes to the various types of information provided by the individuals and health care providers. These can include, but are not limited to, the type of symptoms experienced by the individual, the disease the individual has, the types of treatment in which the health care provider specializes, and other information relating to treatment and medical history. The system can assign identical identification codes to varying terminology when the differing words are synonymous or closely related, thereby ensuring that individuals receive information provided by clinical trial providers that specialize in the individual's particular area of concern, regardless of potential medical terminology confusion.

Continuing with FIG. 1, the system can then utilize the different identification codes combined with information previously collected by the system to predict which clinical trial providers are most likely to effectively treat an individual's specific ailment at block 110. Generally, a predictive algorithm can be used. In one embodiment, the algorithm can take into account treatment dates provided by the clinical trial providers. Dependent on the severity of the disease, the system can compute critical dates and the likelihood of the disease spreading quickly to match the individuals with clinical trial providers. In another embodiment, the algorithm can compute the distance between the individuals and the clinical trial providers. In yet another embodiment, the algorithm can take into account sex, ethnicity, etc. One skilled in the relevant art will appreciate that there are numerous types of algorithms that can be used to predict whether the individual can be matched with a clinical trial provider and the scope of the present disclosure is not limited to those algorithms described above.

At block 112, the system can notify the individual of its predicted matches. In one embodiment, the algorithm provided above can rank the clinical trial providers. In the embodiment, the highest ranking clinical trial providers can be displayed. Generally, the other clinical trial providers can be accessed by the individual through methods known to those skilled in the relevant art. When displayed, the clinical trial providers can provide a brief description of the types of diseases or conditions they treat, where they are located, the costs involved for the treatment, and other pertinent information that the individual would be interested in. In one embodiment, the individual can click on the displayed clinical trial provider and a more detailed description of the clinical trial provider can be provided.

At block 114, the system can alert clinical trial providers of the existence of individuals participating in the system that can potentially benefit from the clinical trial providers' services. Typically, the system provides a limited set of information to the clinical trial providers. This information can include public information. Public information can typically contain redacted information that was entered into the forms by the individual. In one embodiment, the redacted information would remove the names of the specific individual, any particular ailments, etc. Instead, the redacted information can include the sex and age of the individual. Numerous different types of redacted information can be provided to the clinical trial provider. Typically, the system protects the identity of the individuals participating in the system by releasing confidential information provided by individuals after personal identifiable information has been removed and replaced by non-identifiable code numbers to an interested clinical trial provider following the specific individual's authorized approval. This can ensure that the clinical trial provider does not have automatic direct access to the individual, as the system is an intermediary between the clinical trial provider and the individual.

At block 116, the system can enable the clinical trial providers to notify individuals of the availability of new clinical trials and other developing forms of treatment via a request to the system. In one embodiment, the clinical trial providers can continuously query the database for new individuals. Once these new individuals are found, the clinical trial providers can contact them.

At determination block 118, the individual can have the option to either allow or deny contact with the clinical trial provider following the individual's notification by the system. This can protect individuals from unwanted solicitations while preventing potential abuse by the participating clinical trial providers. If the individual decides to allow contact with the clinical trial provider, the system can release the individual's contact information to the clinical trial provider at block 120.

At block 122, and optionally, the system can collect follow-up information from successfully matched participating individuals and clinical trial providers during and following treatment. This information can relate to the success of the match of the individual with a given clinical trial provider and includes, but is not limited to, the actions taken by the clinical trial provider with respect to the individual, any treatment refused by the individual, the goals the clinical trial provider intended to achieve by performing the actions, theorized explanations for why particular goals were not achieved, and the degree of the individual's satisfaction with the clinical trial provided. This information can be incorporated into the system to allow the system to adjust the algorithm of block 110. This can continually update the rate of likelihood of a future match of a particular clinical trial provider with individuals. The system can provide particular information by tracking the degree of the clinical trial providers' success with respect to individuals providing similar information and also with respect to various areas of treatment for particular ailments, thereby potentially changing the system's future match suggestions at block 124. The routines can end at block 126.

Although the method of the present disclosure can be accomplished in the absence of computers or electronics, the following will describe an automated system for carrying out the method of the present disclosure. Typically, the system can be designed to automatically upgrade new drugs, genes and biomarkers discovered, or changes in diagnostic codes and procedure codes. The routines provided above describe a system that is responsive to the clinical trials and individuals seeking information. Through the openness of the system, pharmaceutical companies that are recognized as legitimate can have access to the database of information. If they do start to enroll individuals from the database into such clinical trials that have not be assigned a clinical trial number, then typically they have the ability through the system to be informed of those clinical trials. With a large database it can be possible for researchers, such as the NIH, to access data to determine clinical practice standards of different communities and countries thus being able to evaluate on a real-time basis good and poor clinical practice methods by disease.

In some embodiments, the individual, pharmaceutical companies, etc. can provide ratings. These ratings can take place in an open forum known to those skilled in the relevant art. These ratings can denote whether the clinical trial program is beneficial or not beneficial. This provides a further transparency to the overall system making the more likelihood of use of the system.

Disease and Procedure Codes

Identification codes were described in light of the flow chart provided above. It should be understood that there can be a great deal of confusion in medical terminology due to either abbreviations used, multiple use of particular terms, or simply misunderstanding by individuals. For example, the term adenocarcinoma can be confusing since it does not that the adenocarcinoma could be of the breast, lung, uterus, etc.

To help solve these issues, the system can incorporate into the database existing disease and procedure codes that are known in the US and Internationally. In the US, ICD-9 codes are used for diseases and CPT-9 codes for medical procedures. However, in the rest of the world, CPT codes are not used. Instead, the rest of the world uses ICD-10 codes which can be used for both coding a diagnosis as well as a medical procedure. In the US, ICD-10 will be introduced in 2013, and when introduced will be used only as a diagnosis code. When it comes to cancer, there is yet another coding system called ICD-O-3. The system described herein can utilize each of these codes and further, interchange the codes to clarify both diagnosis and medical procedures and to eliminate confusion.

In addition, there is even more confusion with drug names and gene symbols. Drugs can often be referred to by a trade name, not the generic name and often they are used interchangeably. Because of this, the system includes a list of all trade names, generic names, and synonyms. These have been associated with different codes that can be used internationally such as CAS# and NIH#.

Gene symbols are also a big problem with articles discussing a cancer causing gene but using a symbol not recognized as its official symbol. Genes can be identified by code numbers. The system can include a list of at least fifteen hundred genes dealing with cancer, assigned the appropriate code numbers, listed all available aliases and synonyms associated with the official symbol so that there is proper organization and consistency to genes, their function, and their role in different cancers and diseases.

Environment

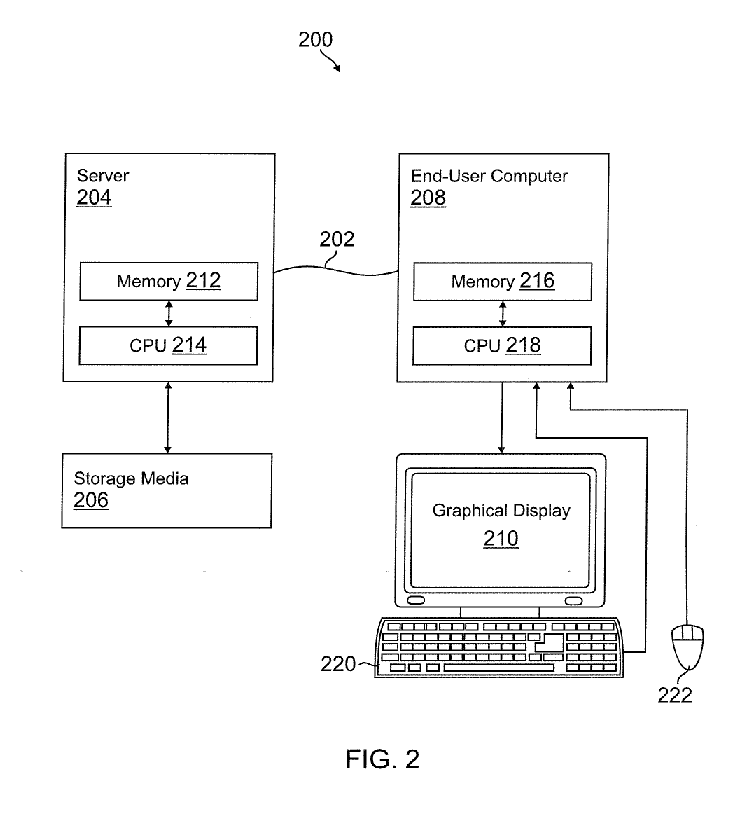

Referring to FIG. 2, an environment 200 which carries out the routines of the present disclosure is provided. As shown, a server 204 can be coupled to a signal-bearing media in the form of hard disk storage 206 having program instructions. The server can include an algorithm for matching individuals with clinical trial providers, enabling the system to practice portions of a method in accordance with an embodiment of the present disclosure that are loaded into a memory 212 and executed by one or more central processing units 214 (CPU). The server 12 can be coupled to an end-user computer 208 via a network connection 202, which can be an Ethernet connection coupled to routers, bridges or other terminal equipment for connection to a wide-area network, and thereby to the Internet. Alternatively, the network connection can be a modem, DSL or cable modem connection coupled to end-user computer 208 for direct connection to the Internet as is typical in home installations. As such, the network connection 202 represents a connection to the Internet or other suitable platform for connection to remote systems such as a server 204.

The end-user computer 208 can be used to request medical information from the server 204. By sending forms from the server 204 to an end-user computer 206, which was defined at block 104, a participating clinical trial provider or an individual can be matched with the individual operating the end-user computer 206. The end-user computer 206 can be coupled to a graphical display 210 and input devices such as a keyboard 220 and mouse 222 enabling participating parties to view the detailed forms on the graphical display 210 and provide information requested by the detailed forms into text boxes via the input devices 220 and 222.

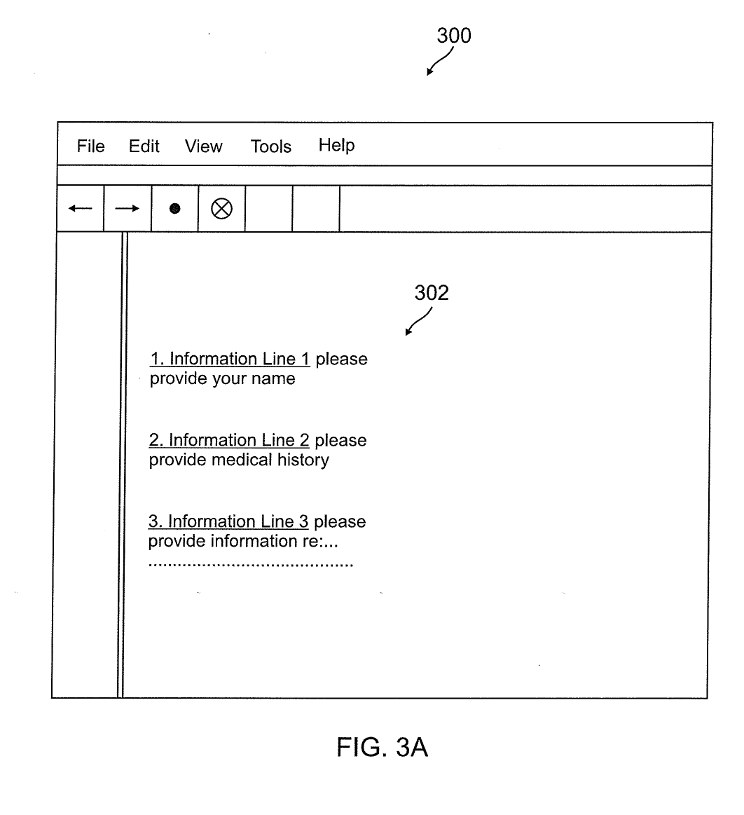

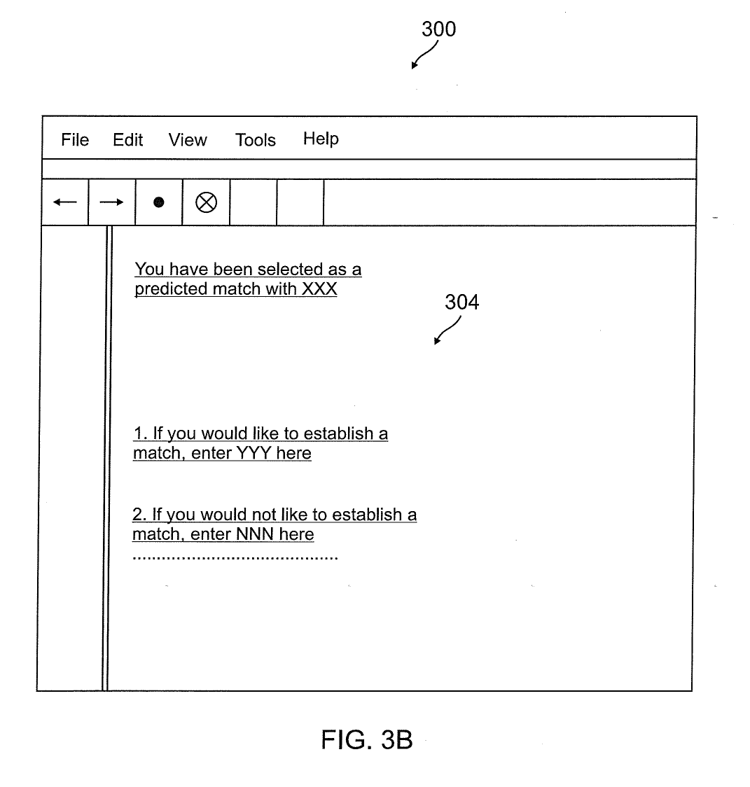

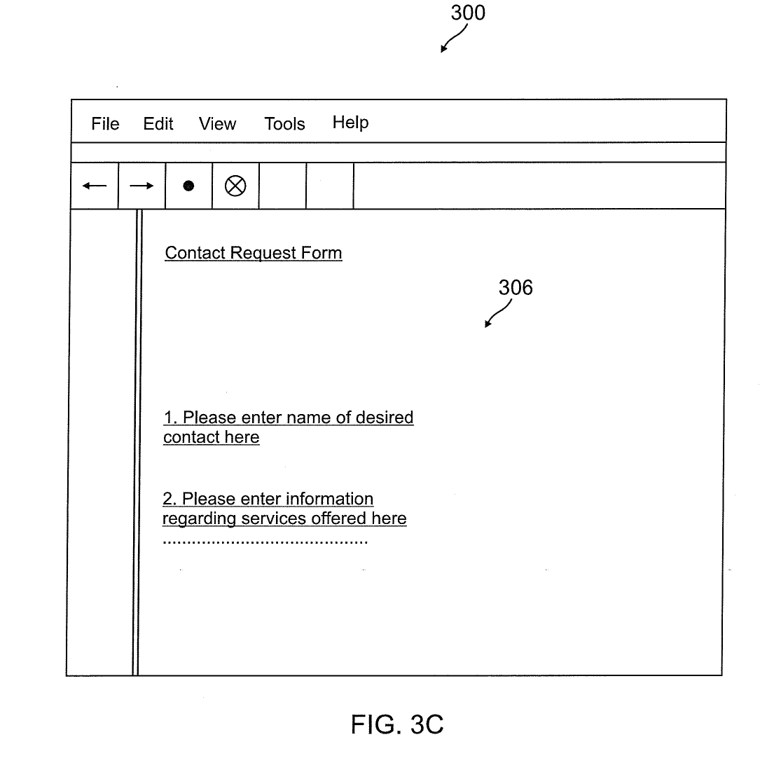

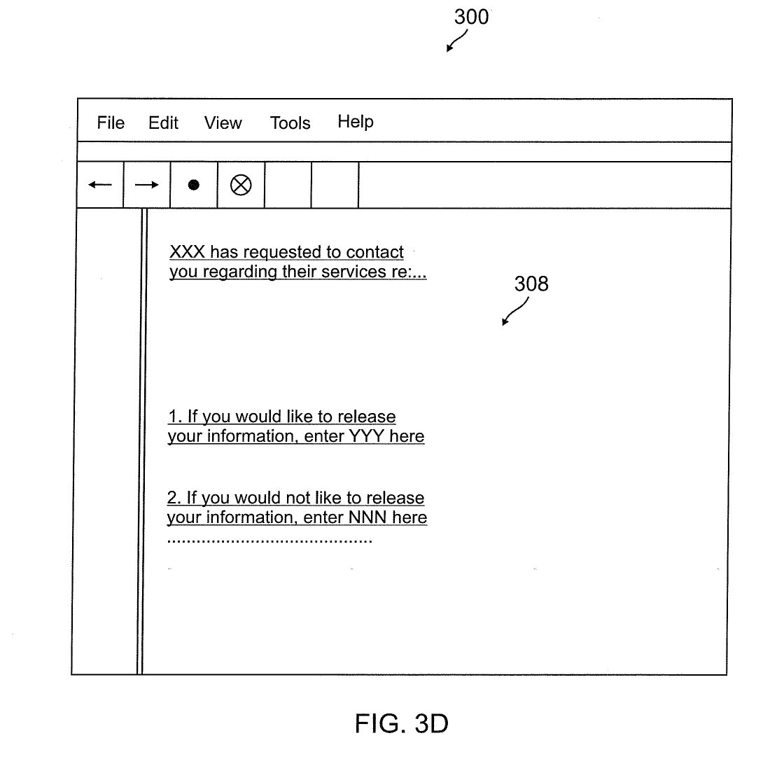

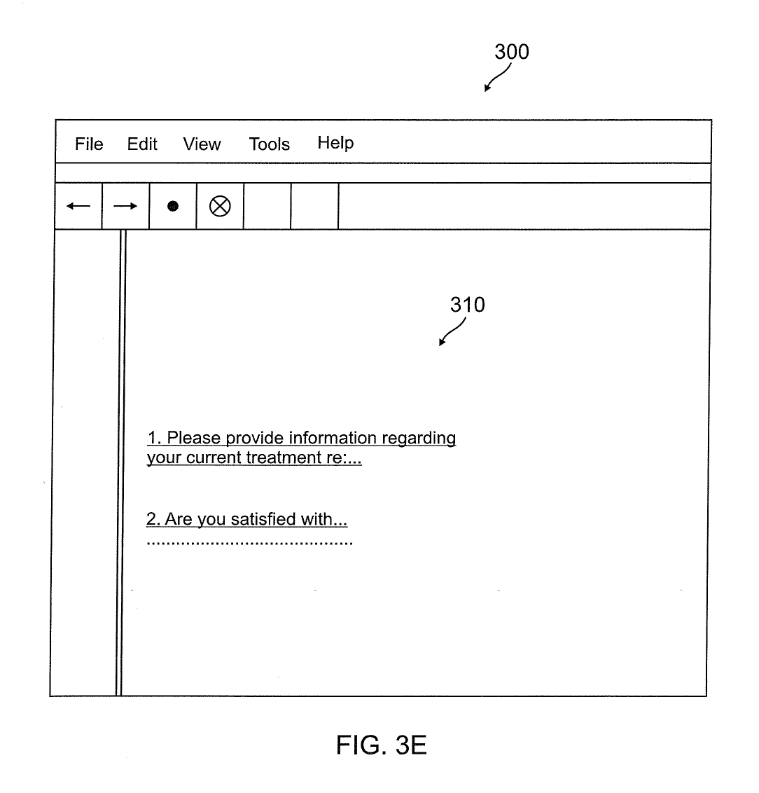

As shown in FIG. 3A, a browser 300 can be provided on the graphical display 210 that shows a typical electronic form 302. The form 302, in the provided embodiment, can prompt the patient for their name, medical history and other related information. The information can then be returned via the network to the server 204, and the server 204 can compile the information received using the CPU 214. The server 204 can store the information in hard disk storage 206, which was defined at block 106. The server 204 can then assign a code to each bit of information provided based upon a predefined coding system stored in memory 206, which was defined at block 108. The CPU 214 can then use a predefined algorithm stored in memory 206 to predict appropriate matches of health care providers with individuals, which was defined at block 110.

The server 204 can then use the network to deliver a match message 304 that can be displayed on the browser 300, which is depicted in FIG. 3B. The match message 304 to the individuals' and the clinical trial providers' end-user computers 202 can show that they have been selected for a predicted match, which were defined at blocks 110 and 112. This can allow the parties to establish a match or to deny a match using text boxes. This can allow health care providers to direct a request message 306 on browser 300, depicted in FIG. 3C, to the server 204. This can indicate that the system would like to deliver information to an intended individual's end-user computer 206 regarding its services by entering information into text boxes 306 on the request message 306, which was defined at block 116.

The server 204 can then send to each individual selected for a match, a release message 308 on browser 300, depicted in FIG. 3D, to request the release of the individual's confidential information to the matched clinical trial provider, defined at block 118. The system can send the release message 308 to their end-user computer 206. The release message 308 can contain text boxes for providing the user's response to the system. If the individual then responds to the request affirmatively using the input devices 220 and/or 222, the server 204 can release the individual's information contained within the memory 212 of the system to the applicable clinical trial provider's end-user computer 206.

The server 204 can periodically send a follow-up message 310 on browser 300, depicted in FIG. 3E, to each participating party's end-user computer 206. The follow-up message 310 can request for various information regarding the status and satisfaction of their treatment or program, which was defined at block 122. The information can be capable of being inserted into text boxes. Each party can then be able to enter the requested information using the input devices 220 and/or 222 and send the information from their end-user computer 206 to the server 204. The server can then use the information to potentially manipulate the algorithm used by the CPU 214, which was defined at block 110, to enable the system to make more accurate predictions in the future.

While embodiments of the disclosure have been described in terms of various specific embodiments, those skilled in the art will recognize that the embodiments of the disclosure can be practiced with modifications within the spirit and scope of the present disclosure.

Registration

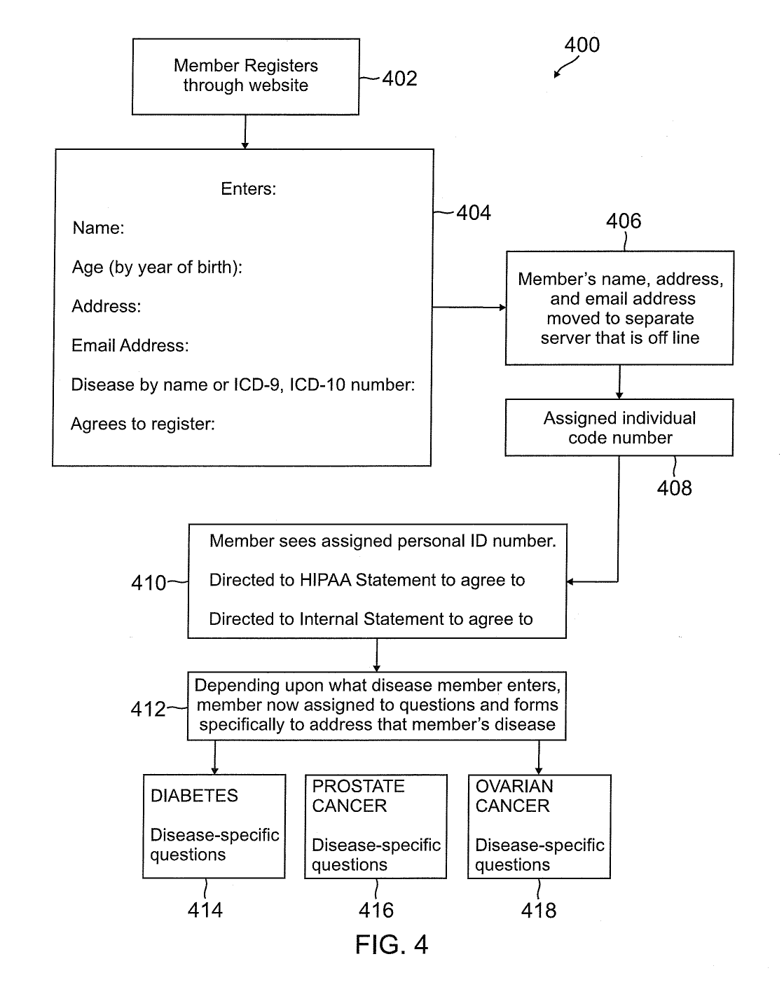

FIG. 4 provides an exemplary flow chart 400 for registering individuals in accordance with one aspect of the present disclosure. While several features are provided below, those skilled in the relevant art will appreciate that the flow chart 400 shown does not represent any particular sequence used by the system. Instead, the flow chart 400 has been provided for illustrative purposes and can be one of many embodiments.

At block 402, the flow chart 400 can begin its sequence for registering individuals. Typically, and within the context of the discussion provided above, the registration can take place through a website. Websites can include a group of related HTML documents and associated files, scripts and databases that are served up by an HTTP server on the World Wide Web.

Through the browser 300, the individual can enter their information in at block 404. The information can include, but is not limited to, the name, age, address, email address, and disease by name. Generally, the disease by name can include an ICD number. In some embodiments, the received information can indicate whether the individual agrees to register. At block 406, the information can be moved to a separate server that is offline. The system can often maintain a separate database.

At block 408, the system can assign an individual code number to the information. As provided for earlier, the code numbers can be later used to match the individual with the clinical trial facility or health care providers. At block 410, the individual can see their assigned personal ID number. This ID number can be used internally to separate the non-redacted information from the redacted information. For example, an individual can be known by an ID number rather than their name. The individual can be directed to agree to a HIPAA statement as well as an internal statement.

At block 412, the individual can be assigned to questions and forms specifically to address an individual's disease. Typically, this is dependent on the diseases that are listed by the individual. While some diseases are specifically provided for at blocks 414, 416, and 418, these are for illustrative purposes only and one skilled in the relevant art will appreciate that there are numerous types of forms for other infirmities that can be provided by the system described herein. At block 414, and in one embodiment, a diabetes form can be provided that asks disease specific questions. In another or related embodiment, a prostate cancer form that asks disease specific questions can be provided as shown at block 416. Still yet, an ovarian cancer form that asks disease specific questions can be provided as shown at block 418.

Individuals

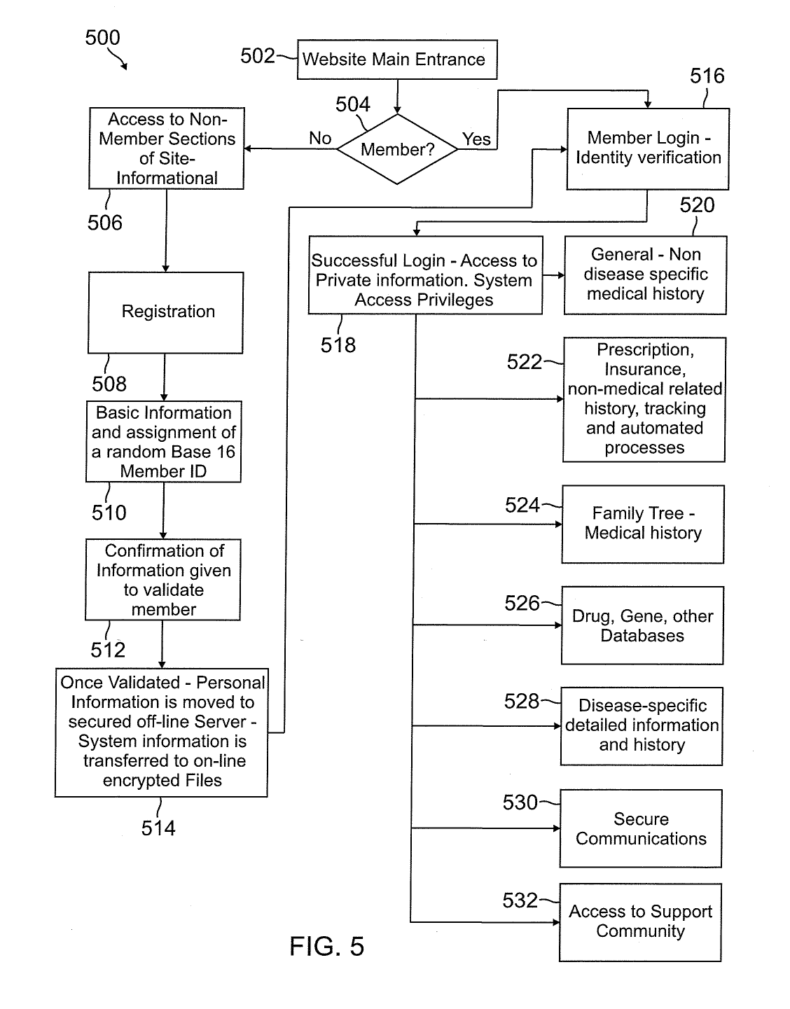

With reference to FIG. 5, illustrative features from the perspective of an individual in accordance with one aspect of the present disclosure are provided. The flow chart 500 can begin at block 502. Typically, the system can be accessed through the same website provided earlier. At determination block 504, the system determines whether the individual is registered. To be a registered, the individual usually maintains a personal ID number.

When the individual has not been registered, the individual can have access to sections having limited access to the site at block 506. The individual can register at block 508. At block 510, an individual ID can be assigned to the non-registered me individual individual. In one embodiment, the ID can be a base sixteen number. At block 512, information can be given to validate the individual. At block 514, the personal information of the individual is moved to a secured off-line server once the individual has been validated. In addition, the system information can be transferred to on-line encrypted files. Thereafter, control is provided to block 516.

Returning to determination block 504, if the individual is recognized then control is provided to block 516 where the individual is required to login for identity verification. Several methods can be used for verifying an individual. For example, the system can ask for the individual's birth date, mother's maiden name, etc. At block 518, the individual can gain access to private information after a successful login. The system can provide access privileges to a variety of different features shown in blocks 520, 522, 524, 526, 528, 530, and 532.

While the system maintains numerous features, those mentioned below are for illustrative purposes and should not be construed as limiting the scope of the present disclosure. At block 520, the individual can access the general medical history. Generally, these are non-disease specific. At block 522, the individual can access prescription, insurance, non-medical related history, tracking and automated processes. In one embodiment, the individual can access the family tree, and in more particular, any medical histories that can be passed through the individual's generation at block 524. At block 526, the individual can access drug, gene, and other databases. At block 528, and in another or related embodiment, the individual can access disease-specific detailed information and history. At block 530, the individual can access secured communications. At block 532, the individual can have access to support the community. Numerous other embodiments known to those skilled in the relevant art can be incorporated within the current system and those provided above are not intended to limit the scope of the present disclosure.

Pharmaceutical Coordinator

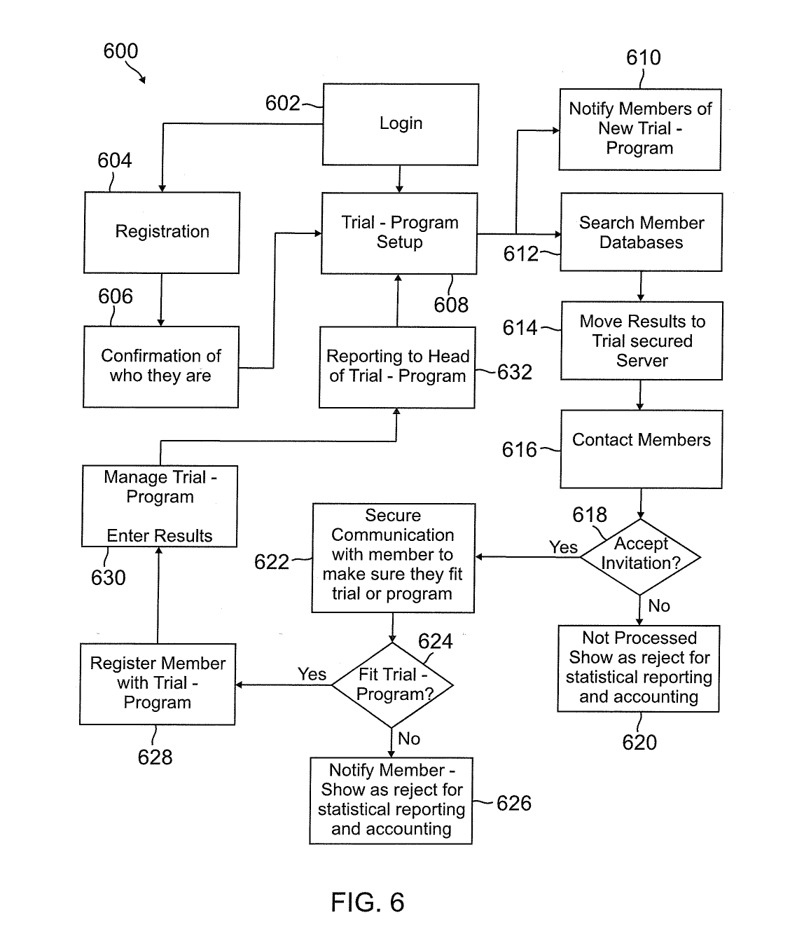

FIG. 6 shows illustrative features from the perspective of a pharmaceutical coordinator in accordance with one aspect of the present disclosure. The flow chart 600 provides numerous features from pharmaceutical coordinators. In general, however, the flow chart 600 is not limited to pharmaceutical coordinators. Instead, the routines provided herein can be associated with clinical trial and health care providers. The flow chart can begin at block 602 where the pharmaceutical coordinator can log in. Typically, this occurs through the entering of a user name and password by the pharmaceutical coordinator.

At block 604, the pharmaceutical coordinator can register if they have not registered already. Continuing, and at block 606, the pharmaceutical coordinator can confirm who they are. The pharmaceutical coordinator can confirm by entering in a series of answers to questions provided by the system. Afterwards, control can be provided to block 608. At block 608, the pharmaceutical coordinator can setup a clinical trial treatment or program.

After the trial programs are established, the pharmaceutical coordinator can notify individuals of the new trial program at block 610. Typically, this can be provided in an all-out treatment campaign. The campaign can be displayed through advertisements provided within the system. Alternatively, at block 612, the pharmaceutical coordinator can search through databases that include information provided by the individuals. The databases can be queried for matching criteria or information provided earlier by each individual. At block 614, the results are moved to a secured server.

At block 616, the individuals can be contacted that have been matched with the trial program. In one embodiment, all individuals that have been matched are contacted. Alternatively, the system can allow the pharmaceutical coordinator to refine the query. Still yet, the pharmaceutical coordinator can select a few individuals to be contacted.

At determination block 618, the system can decide whether the patient has accepted the invitation for the clinical trial. When the individual does not accept, the individual is not processed into the trial study at block 620. Furthermore, the system can show that the individual as a reject for statistical reporting and accounting. On the other hand, and when the invitation for the trial is accepted, a secure communication with the individual to make sure that they fit the trial or program is provided at block 622.

At determination block 624, the system or pharmaceutical coordinator can decide whether the individual fits the trial program. The system can decide based on preset criteria provided by the pharmaceutical coordinator. When the individual does not fit within, the individual is notified at block 626. The system shows the individual as a reject for statistical reporting and accounting. If the individual is accepted into the trial program, the individual is registered with the trial program at block 628. During this process, the individual can submit additional information for beginning the trial.

At block 630, the system can manage the trial program. At this point, the individual can provide results. Those results can be reported to the head of the trial program at block 632. Control is then returned back to block 608. While numerous elements were presented above, one skilled in the relevant art will appreciate that fewer or more elements can be provided for and those elements provided above are not intended to limit the scope of the present disclosure.

Professional Subscriber

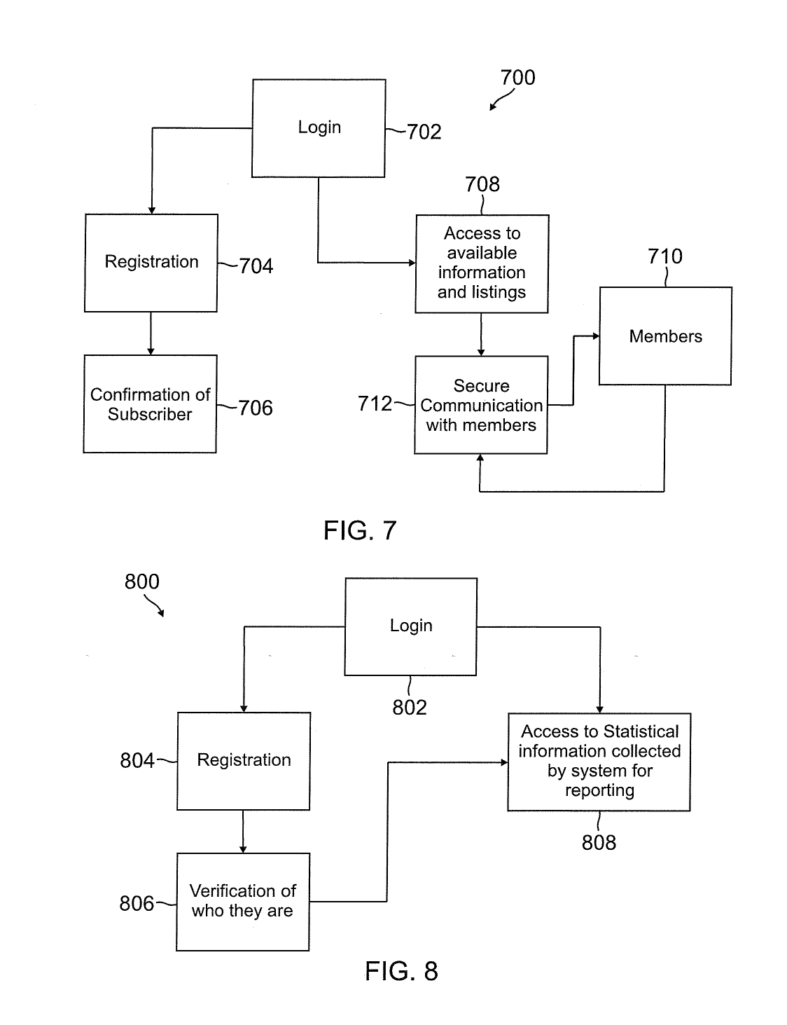

As shown above, individuals and pharmaceutical coordinators were described. Each of these components could interact with the system. In addition to those components, a professional subscriber can communicate with the system as depicted in FIG. 7. The flow chart 700 can begin at block 702 where the professional subscriber can login. The professional subscriber can typically login by entering a user name and password. The professional subscriber can register themselves at block 704 if they have not done so. At block 706, the professional subscriber can be confirmed as a subscriber.

At block 708, the professional subscriber can gain access to available information and listings. The professional subscriber can use secure communications with individuals at block 712 with the individuals located at block 710. While numerous elements were presented above, one skilled in the relevant art will appreciate that fewer or more elements can be provided for and those elements provided above are not intended to limit the scope of the present disclosure.

Research Institution

FIG. 8 shows illustrative features from the perspective of a research institution in accordance with one aspect of the present disclosure. The flow chart 800 can begin at block 802 where the research institution can login. The research institution can typically login by entering a user name and password.

If the research institution has not logged in, the research institution can register at block 804. At block 806, the system can verify the research institution. Afterwards, control can be provided to block 808. After logging in, the research institution can have access to statistical information collected at block 808.

System and Methods of Operation

As previously described, the present disclosure describes a system and method for matching individuals with health care providers. In accordance with one aspect of the present disclosure, the system provides detailed forms designed to elicit specific medical information from individuals and health care providers. The system can collect and compile the information using the detailed forms from individuals and health care providers agreeing to participate in the system. The system can assign different identification codes to each individual and health care provider participating in the system.

The system can assign identification codes to the various types of information provided by the individuals and health care providers. Identification codes can be provided for types of symptoms experience by the individual, the disease the individual has, the types of treatment in which the health care provider specializes, and other information relating to treatment and medical history.

The system can assign identical identification codes to varying terminology when the differing words are synonymous or closely related. This can allow individuals to receive information provided by clinical trial providers that specialize in the individual's particular area of concern regardless of potential medical terminology confusion.

The system can utilize the different identification codes combined with information previously collected by the system to develop an algorithm to predict which clinical trial providers are most likely to effectively treat an individual's specific ailment. The system can then notify the individual of its predicted matches. The system can also alert clinical trial providers of the existence of individuals participating in the system that can potentially benefit from the clinical trial providers' services.

The system can enable the clinical trial providers to notify applicable individuals of the availability of new clinical trials and other developing forms of treatment via a request to the system. If the individual decides to allow contact with the clinical trial provider, the system releases the individual's contact information to the clinical trial provider.

In accordance with another aspect of the present disclosure, a computer-implemented method for setting up individuals with clinical trial providers is provided. The computer-implemented method includes receiving medical information from an individual. In addition, the computer-implemented method includes matching the individual to the clinical trial providers using the medical information. The computer-implemented method also includes releasing private information of the individual to the matched clinical trial providers when authorized by the individual.

In one embodiment, matching the individual to the clinical trial providers includes determining ailments based on the medical information and selecting the clinical trial providers that treat the ailments. In one embodiment, matching the individual to the clinical trial providers using the medical information includes ranking the clinical providers that treat the ailments. In one embodiment, the computer-implemented method further includes providing the clinical trial providers with redacted information about the individual before releasing private information of the individual to the matched clinical trial providers when authorized by the individual.

In one embodiment, the computer-implemented method further includes notifying the individual of the matched clinical trial providers before releasing private information of the individual to the matched clinical trial providers when authorized by the individual. In one embodiment, the computer-implemented method further includes ensuring that the clinical trial providers do not have direct access to the individual unless authorized. In one embodiment, the computer-implemented method further includes collecting follow-up information from the individuals and the clinical trial providers. In one embodiment, the computer-implemented method includes measuring successful matches between the individual and the clinical trial providers.

In accordance with yet another aspect of the present disclosure, a medical record system is provided. The medical record system includes a database for storing information about at least one participating clinical trial facility that provides treatment for one or more disease classifications. In addition, the medical record system includes at least one processor and a memory operatively coupled to the processor, the memory storing program instructions which, when executed by the processor, causes the processor to perform processes. The processes include receiving at least one disease classification. In addition, the processes include enabling a clinical trial facility of the at least one participating clinical trial facility to become aware of the individual by matching the one or more disease classifications of the clinical trial facility with the individual's disease classifications.

In one embodiment, the disease classifications include an International Classification of Diseases, Clinical Modification. In one embodiment, the International Classification of Diseases, Clinical Modification ensures that cross-terminology matches are made. In one embodiment, the cross-terminology matches are made using synonymous or closely related terms. In one embodiment, the International Classification of Diseases, Clinical Modification identifies specific cancer or diseases.

In one embodiment, the memory storing program instructions which, when executed by the processor, causes the processor to further notify the individual of new clinical trials. In one embodiment, the memory storing program instructions which, when executed by the processor, causes the processor to further notify the individual of other developing forms of treatment. In one embodiment, the memory storing program instructions which, when executed by the processor, causes the processor to further allow the clinical trial facility to contact the individual requesting for full information from the individual.

In one embodiment, the memory storing program instructions which, when executed by the processor, causes the processor to further allow the individual to release their full information to the clinical trial facility. In one embodiment, the memory storing program instructions which, when executed by the processor, causes the processor to further allow the individual to deny their full information to the clinical trial facility.

In accordance with still yet another aspect of the present disclosure, a system is provided. The system includes at least one individual providing disease specific information. In addition, the system includes a medical information network for receiving the disease specific information from the individual. The system also includes at least one clinical trial facility for retrieving the disease specific information from the medical information network, the at least one clinical trial facility providing treatments for the disease specific information of the at least one individual.

In one embodiment, the medical information network complies with a Health Insurance Portability and Accountability Act.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A medical record system comprising:
a database for storing information about at least one participating clinical trial facility that provides treatment for one or more disease classifications;
at least one processor; and
a memory operatively coupled to said processor, said memory storing program instructions which, when executed by said processor, causes said processor to:
receive at least one individual's disease classification;
enable a clinical trial facility of said at least one participating clinical trial facility to become aware of said individual by matching said one or more disease classifications of said clinical trial facility with said individual's disease classifications.

2. The medical record system of claim 1, wherein said disease classifications comprise an International Classification of Diseases, Clinical Modification.

3. The medical record system of claim 2, wherein said International Classification of Diseases, Clinical Modification ensures that cross-terminology matches are made.

4. The medical record system of claim 3, wherein said cross-terminology matches are made using synonymous or closely related terms.

5. The medical record system of claim 2, wherein said International Classification of Diseases, Clinical Modification identifies specific cancer or diseases.

6. The medical record system of claim 1, wherein said memory storing program instructions which, when executed by said processor, causes said processor to further notify said individual of new clinical trials.

7. The medical record system of claim 1, wherein said memory storing program instructions which, when executed by said processor, causes said processor to further notify said individual of other developing forms of treatment.

8. The medical record system of claim 1, wherein said memory storing program instructions which, when executed by said processor, causes said processor to further allow said clinical trial facility to contact said individual requesting for full information from said individual.

9. The medical record system of claim 8, wherein said memory storing program instructions which, when executed by said processor, causes said processor to further allow said individual to release their full information to said clinical trial facility.

10. The medical record system of claim 8, wherein said memory storing program instructions which, when executed by said processor, causes said processor to further allow said individual to deny their full information to said clinical trial facility.

11. A system comprising:
at least one individual providing disease specific information;
a medical information network for receiving said disease specific information from said individual;
at least one clinical trial facility for retrieving said disease specific information from said medical information network, said at least one clinical trial facility providing treatments for said disease specific information of said at least one individual.

12. The system of claim 11, wherein said medical information network complies with a Health Insurance Portability and Accountability Act.
